(19) United States
(12) Patent Application Publication
(10) Pub. No.: US 2026/0255324 A1
(43) Pub. Date: Aug. 27, 2026

(54) MEDIUM ACCESS CONTROL PROTOCOL DATA UNITS ASSOCIATED WITH COOPERATIVE USER EQUIPMENT GROUPS

(71) Applicant: QUALCOMM Incorporated, San Diego, CA (US)

(72) Inventors: Hua WANG, Basking Ridge, NJ (US); Navid ABEDINI, Basking Ridge, NJ (US); Qing LI, Princeton Junction, NJ (US); Mostafa KHOSHNEVISAN, San Diego, CA (US); Sony AKKARAKARAN, Poway, CA (US); Qian ZHANG, Basking Ridge, NJ (US); Xiaoxia ZHANG, San Diego, CA (US); Tao LUO, San Diego, CA (US); Junyi LI, Greentown, PA (US)

(21) Appl. No.: 19/061,258

(22) Filed: Feb. 24, 2025

(51) Int. Cl. H04W 72/04

(52) U.S. Cl. CPC H04W 72/04

(57) ABSTRACT

Various aspects of the present disclosure generally relate to wireless communication. In some aspects, a user equipment (UE) may communicate a medium access control (MAC) protocol data unit (PDU) that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group. The UE may perform an action based at least in part on the MAC PDU. Numerous other aspects are described.

### FIELD OF THE DISCLOSURE

Aspects of the present disclosure generally relate to wireless communication and specifically relate to techniques, apparatuses, and methods associated with medium access control protocol data units associated with cooperative user equipment groups.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### BRIEF DESCRIPTION OF THE DRAWINGS

FIG. 1 is a diagram illustrating an example of a wireless network.

FIG. 2 is a diagram illustrating an example disaggregated base station architecture.

FIG. 3 is a diagram illustrating an example of user equipments (UEs) without cooperation and UEs with cooperation.

FIG. 4 is a diagram illustrating an example of cooperative UEs.

FIGS. 5-8 are diagrams illustrating examples associated with medium access control protocol data units associated with cooperative UE groups.

FIG. 9 is a flowchart illustrating an example process performed, for example, by a UE.

FIG. 10 is a flowchart illustrating an example process performed, for example, by a network node.

FIGS. 11-12 are diagrams of example apparatuses for wireless communication.

### SUMMARY

The systems, methods, and devices of this disclosure each have several innovative aspects, no single one of which is solely responsible for the desirable attributes disclosed herein.

In some implementations, an apparatus for wireless communication at a user equipment (UE) includes one or more memories; and one or more processors, coupled to the one or more memories, configured to cause the UE to: communicate a medium access control (MAC) protocol data unit (PDU) that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group; and perform an action based at least in part on the MAC PDU.

In some implementations, an apparatus for wireless communication at a network node includes one or more memories; and one or more processors, coupled to the one or more memories, configured to cause the network node to: communicate a MAC PDU that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group; and perform an action based at least in part on the MAC PDU.

In some implementations, a method of wireless communication performed by a UE includes communicating a MAC PDU that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group; and performing an action based at least in part on the MAC PDU.

In some implementations, a method of wireless communication performed by a network node includes communicating a MAC PDU that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group; and performing an action based at least in part on the MAC PDU.

In some implementations, a non-transitory computer-readable medium storing a set of instructions for wireless communication includes one or more instructions that, when executed by one or more processors of a UE, cause the UE to: communicate a MAC PDU that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group; and perform an action based at least in part on the MAC PDU.

In some implementations, a non-transitory computer-readable medium storing a set of instructions for wireless communication includes one or more instructions that, when executed by one or more processors of a network node, cause the network node to: communicate a MAC PDU that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group; and perform an action based at least in part on the MAC PDU.

In some implementations, an apparatus for wireless communication includes means for communicating a MAC PDU that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group; and means for performing an action based at least in part on the MAC PDU.

In some implementations, an apparatus for wireless communication includes means for communicating a MAC PDU that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group; and means for performing an action based at least in part on the MAC PDU.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### DETAILED DESCRIPTION

Cooperative user equipments (UEs) may form a cooperative UE group and jointly provide communication and/or computing services to other UEs (e.g., client devices) in the cooperative UE group. In other words, the cooperative UE group may include cooperative UEs that provide the communication and/or computing services to each other. A UE in the cooperative UE group may utilize communication and/or computing services provided by one or more other UEs in the cooperative UE group. The communication and/or computing services may be associated with various types of applications.

The UE in the cooperative UE group may transmit or receive messages (e.g., data messages) that are either targeted to an entire cooperative UE group or to an individual UE that is outside of the cooperative UE group. The messages targeting the UE may be related to cooperative services (e.g., communication/computing services provided to or received from other UEs within the cooperative UE group) or to other activities, such as video streaming. However, at a medium access control (MAC) layer, determining whether the message is for the cooperative UE group, or whether the message is for the individual UE, may not be feasible. The individual UE may be outside of the cooperative UE group, or alternatively, the individual UE may be within the cooperative UE group.

A MAC protocol data unit (PDU) may have one or more MAC subheaders, where each MAC subheader may provide information to decode a corresponding MAC subPDU. For a MAC subPDU to be processed by an Internet Protocol (IP) layer or above (e.g., a MAC service data unit (SDU)), the MAC subPDU may not necessarily indicate at a MAC layer as to whether the MAC subPDU is for the cooperative UE group or for the individual UE. For a MAC subPDU to be processed by a MAC layer, the MAC subPDU may be for the cooperative UE group or the MAC subPDU may be for the individual UE, but such a distinction may not be indicated in the MAC subPDU. For example, the UE may dedicate a different transmit power level to its own traffic versus traffic for the cooperative UE group, such that the UE may have to distinguish between power headroom reports (PHRs) to determine a correct transmit power level. An inability for the MAC subPDU (or the MAC subheader) to indicate whether the MAC subPDU is for the cooperative UE group or for the individual UE may impact a processing of the MAC subPDU at the UE, thereby degrading an overall system performance.

Various aspects relate generally to cooperative UEs. Some aspects more specifically relate to MAC PDUs associated with cooperative UE groups. In some examples, a UE may communicate, to a network node, or alternatively, the network node may communicate to the UE, a MAC PDU that includes a MAC subheader and a MAC subPDU associated with the MAC subheader. The MAC PDU may be associated with a MAC control element (MAC-CE). The MAC-CE may be a group and/or UE-specific MAC-CE for UE cooperation. The MAC subheader may include one or more fields to indicate whether the MAC subPDU is associated with a cooperative UE group or whether the MAC subPDU is associated with an individual UE that is within the cooperative UE group or outside of the cooperative UE group. The one or more fields may include a flag to indicate whether the MAC subPDU is associated with the cooperative UE group or whether the MAC subPDU is associated with the individual UE. In some aspects, the MAC subheader may indicate a group identifier (ID) associated with the cooperative UE group. In some aspects, the MAC subheader may indicate the group ID associated with the cooperative UE group and a UE ID of the individual UE that is within the cooperative UE group. In some aspects, the MAC subheader may indicate a UE ID of the individual UE that is outside of the cooperative UE group.

Particular aspects of the subject matter described in this disclosure can be implemented to realize one or more of the following potential advantages. In some examples, by incorporating the one or more fields in the MAC subheader to indicate whether the MAC subPDU is associated with a cooperative UE group or whether the MAC subPDU is associated with an individual UE that is within the cooperative UE group or outside of the cooperative UE group, the described techniques can be used by the UE and/or the network node to indicate, at a MAC layer, whether the MAC subPDU is for the cooperative UE group or the individual UE. Such a distinction may allow the UE and/or the network node to determine whether the MAC subPDU is associated with cooperative services or other activities, such as video streaming. The distinction may allow the UE and/or the network node to perform actions related to various types of procedures, such as a power headroom reporting, a buffer status reporting, a discontinuous reception (DRX), a secondary cell (SCell) activation, an SCell deactivation, a transmission configuration indicator (TCI) state activation, a TCI state deactivation, a beam failure recovery (BFR), and/or a delay status reporting. An ability to indicate at the MAC layer whether the MAC subPDU is intended for the cooperative UE group or the individual UE, through assigning group IDs to cooperative UE groups and using the one or more fields in the MAC subheader, may improve a resource allocation, a communication efficiency, and/or energy savings in cooperative networks, thereby improving an overall system performance.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

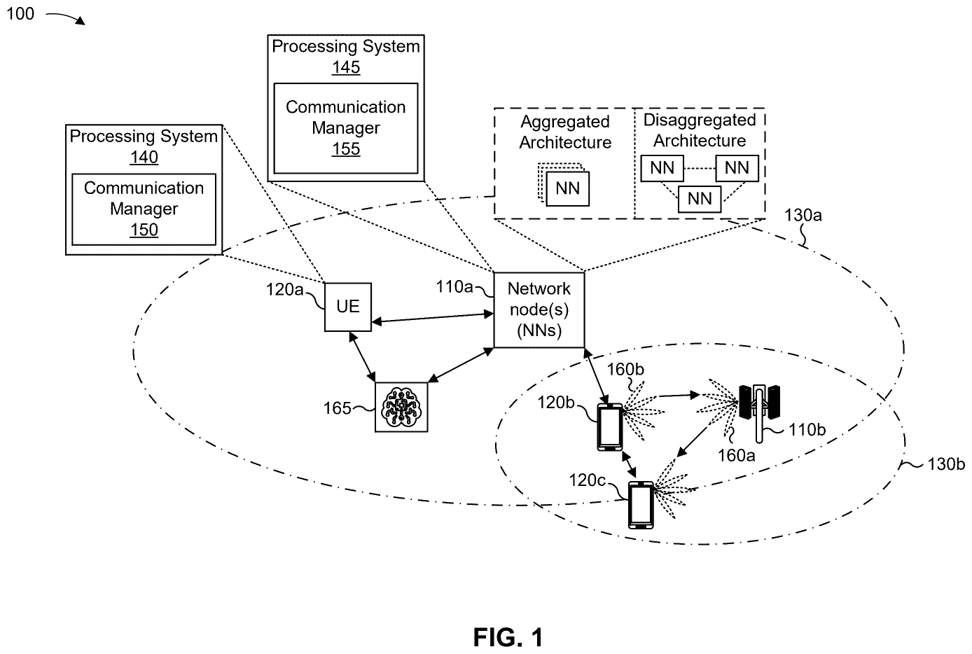

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR 1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a MAC layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC-CE, an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a TCI state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, a UE (e.g., the UE 120) may include a communication manager 150. As described in more detail elsewhere herein, the communication manager 150 may communicate a MAC PDU that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group; and perform an action based at least in part on the MAC PDU. Additionally, or alternatively, the communication manager 150 may perform one or more other operations described herein.

In some aspects, a network node (e.g., the network node 110) may include a communication manager 155. As described in more detail elsewhere herein, the communication manager 155 may communicate a MAC PDU that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group; and perform an action based at least in part on the MAC PDU. Additionally, or alternatively, the communication manager 155 may perform one or more other operations described herein.

As indicated above, FIG. 1 is provided as an example. Other examples may differ from what is described with regard to FIG. 1.

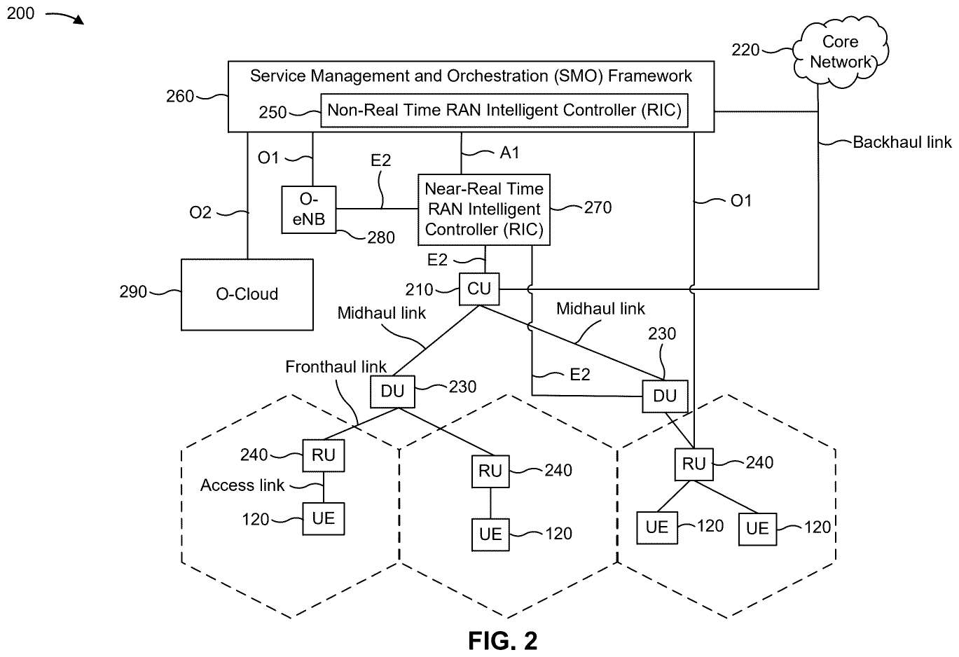

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

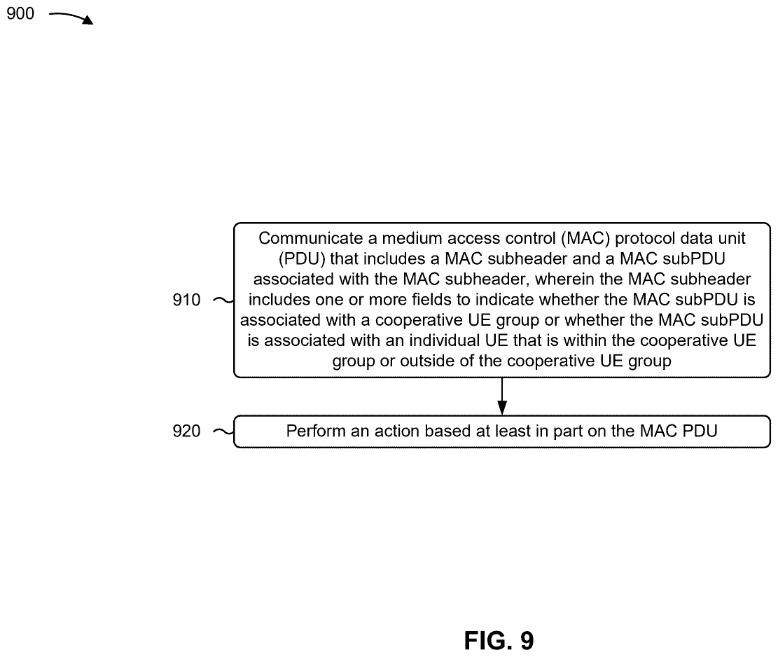

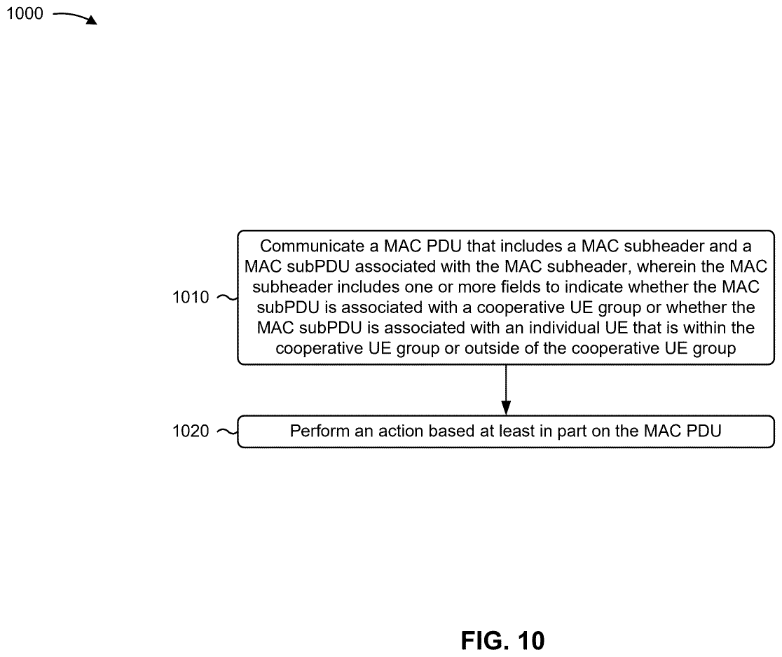

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with MAC PDUs associated with cooperative UE groups, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, or other processes as described herein. In some examples, executing instructions may include running the instructions, converting the instructions, compiling the instructions, or interpreting the instructions, among other examples.

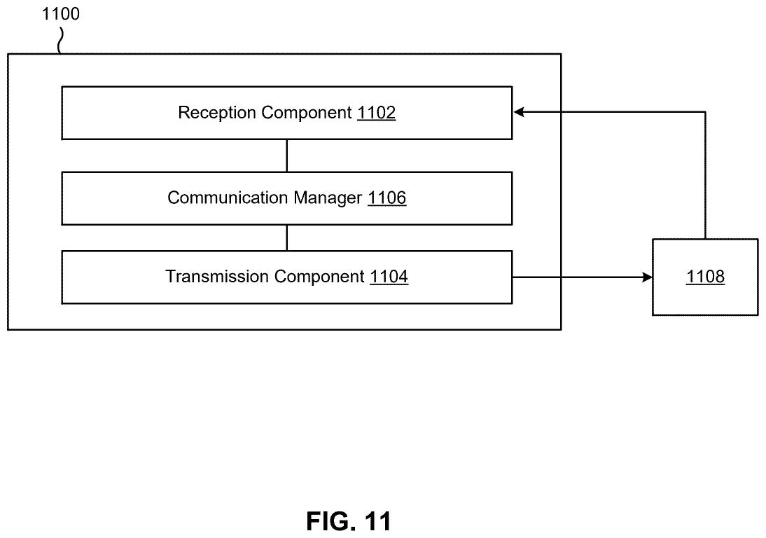

In some aspects, a UE (e.g., the UE 120) includes means for communicating a MAC PDU that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group; and/or means for performing an action based at least in part on the MAC PDU. The means for the UE to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

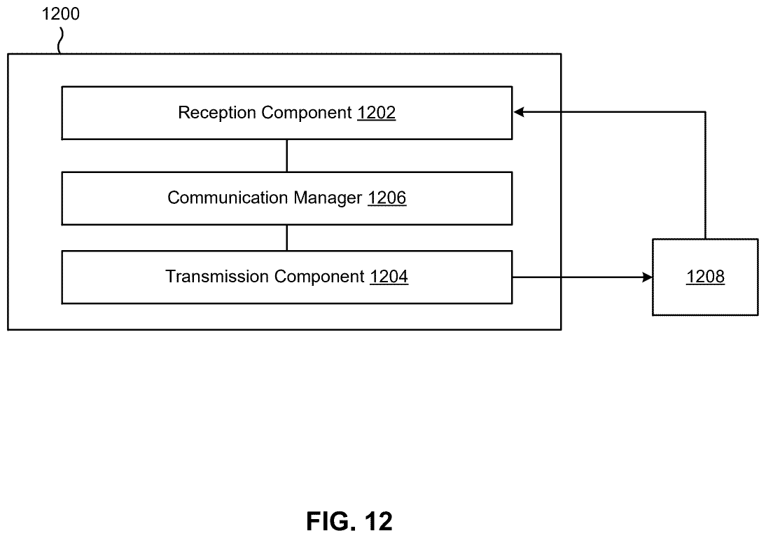

In some aspects, a network node (e.g., the network node 110) includes means for communicating a MAC PDU that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group; and/or means for performing an action based at least in part on the MAC PDU. The means for the network node to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

As indicated above, FIG. 2 is provided as an example. Other examples may differ from what is described with regard to FIG. 2.

A group of UEs may form a cooperative UE group and cooperate together to enable communications among UEs in the cooperative UE group. The cooperative UE group may implement UE cooperation to achieve a coverage enhancement for a UE in the cooperative UE group. The coverage enhancements may be via other UEs in the cooperative UE group for a downlink direction and/or an uplink direction. The cooperative UE group may implement UE cooperation to achieve energy savings for the UE. A UE cooperation may be a generalized multiple TRP (mTRP) operation, where the UE may be equivalent to a TRP. The UE may communicate with a network node, and the UE may jointly serve other UEs in the cooperative UE group as part of the UE cooperation. In one example, the UE cooperation may be used for distributed computing. The UE may use another UE's computing resources for a computation intensive or memory intensive application that runs on the UE.

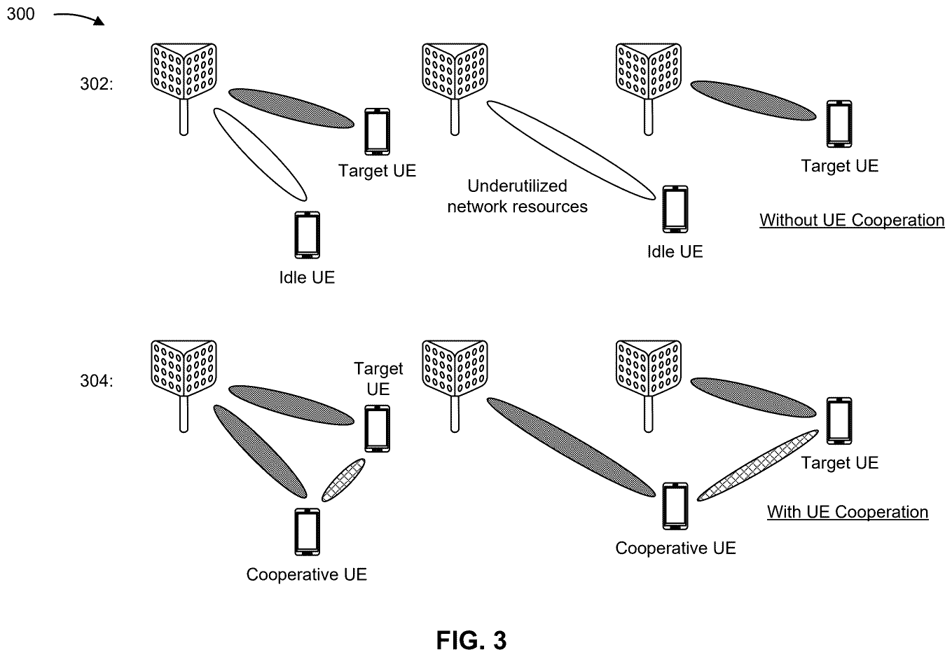

FIG. 3 is a diagram illustrating an example 300 of UEs without cooperation and UEs with cooperation.

As shown by reference number 302, in a scenario without UE cooperation, a first network node may communicate with a first target UE. The first network node may not communicate with a first idle UE, even though the first idle UE may be within a line-of-sight of the first network node. A second network node may not communicate with a second idle UE, even though the second idle UE may be within a line-of-sight of the second network node. A third network node may communicate with a second target UE. Idle UEs may be associated with under-utilized network resources. As shown by reference number 304, in a scenario with UE cooperation, a first network node may communicate with a first cooperative UE and a first target UE. A second network node may communicate with a second cooperative UE. A third network node may communicate with a second target UE. The first cooperative UE may form a link with the first target UE. The second cooperative UE may form a link with the second target UE. With the UE cooperation, cooperative UEs may communicate with target UEs, which may reduce an amount of under-utilized network resources.

As indicated above, FIG. 3 is provided as an example. Other examples may differ from what is described with regard to FIG. 3.

Cooperative UEs may form a cooperative UE group and jointly provide communication and/or computing services to other UEs (client devices) in the cooperative UE group. In other words, the cooperative UE group may include cooperative UEs that provide the communication and/or computing services to each other. A UE in the cooperative UE group may utilize communication and/or computing services provided by one or more other UEs in the cooperative UE group. The communication and/or computing services may be associated with various types of applications. Such applications may include a large language model (LLM) (or inference model) running on the UE. The UE may use computing/memory resources from the other UEs in the cooperative UE group in order to run a relatively large LLM model for inference. The applications may include on-device AI/ML training for communications on a network services platform (NSP). For online device learning, training may utilize the NSP for continuous training and model updates. The applications may include a channel state feedback (CSF) computation distribution. For example, a CSF computation for a smart watch may be offloaded to the UE (e.g., such offloading may be possible due to a relatively relaxed timeline for the smart watch).

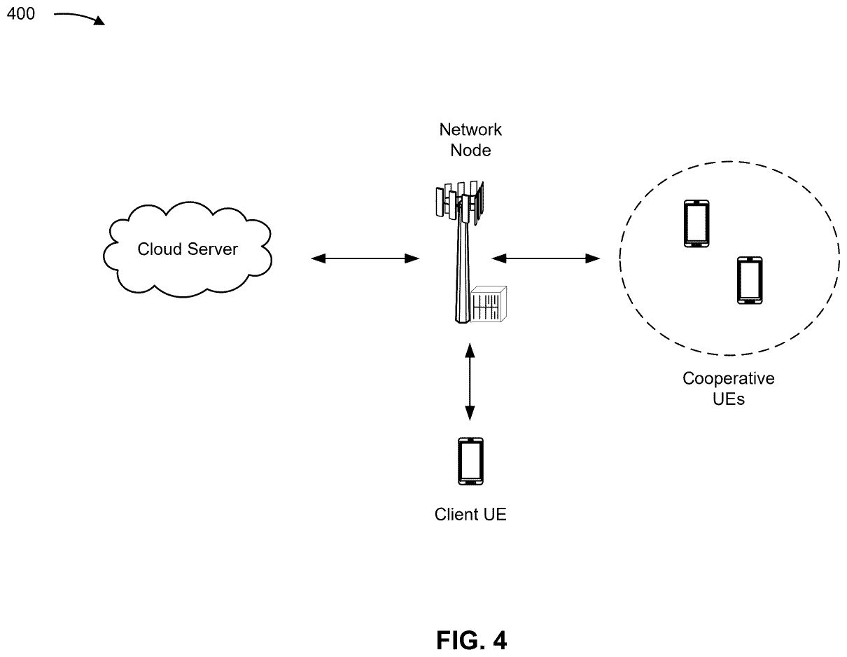

FIG. 4 is a diagram illustrating an example 400 of cooperative UEs.

As shown in FIG. 4, a group of cooperative UEs, a client UE, and/or a cloud server may communicate with a network node. The network node may be associated with a 5G core (5GC) and a RAN. In one example, the cooperative UEs may be in a vicinity of each other, such that the cooperative UEs may be able to cooperate with each other via Wi-Fi or sidelink communications. The cooperative UEs may form a local mesh network. In this example, the client UE may be an individual UE (e.g., a UE that is outside of the group of cooperative UEs). In another example, the cooperative UEs may be in different locations, such that the cooperative UEs may be connected via a core network and/or the Internet. The cooperative UEs may form a mobile edge network. The cooperative UEs may include various types of devices, such as smart phones, smart watches, smart glasses, and other types of devices.

As indicated above, FIG. 4 is provided as an example. Other examples may differ from what is described with regard to FIG. 4.

A UE within a cooperative UE group may transmit or receive messages (e.g., data messages) that are either targeted to an entire cooperative UE group or to an individual UE. The individual UE may be outside of the cooperative UE group, or the individual UE may be within the cooperative UE group. The messages targeting the UE may be related to cooperative services (e.g., communication/computing services provided to or received from other UEs within the cooperative UE group) or to other activities, such as video streaming. However, at a MAC layer, a message may not indicate as to whether the message is for the cooperative UE group, or whether the message is for the individual UE.

A MAC PDU may have one or more MAC subheaders, where each MAC subheader may provide information to decode a corresponding MAC subPDU. For example, the MAC PDU may include a first MAC subheader which may be followed by a first MAC subPDU, the MAC PDU may include a second MAC subheader which may be followed by a second MAC subPDU, and so on. For a MAC subPDU to be processed by an IP layer or above (e.g., a MAC SDU), the MAC subPDU may not necessarily indicate at a MAC layer whether the MAC subPDU is for the cooperative UE group or for the individual UE. In some cases, the MAC SDU may be processed in a lower layer, so distinguishing at the MAC layer may be needed. For a MAC subPDU to be processed by a MAC layer (e.g., a MAC-CE), the MAC subPDU may be for the cooperative UE group or the MAC subPDU may be for the individual UE, but such a distinction may not be indicated in the MAC subPDU. For example, the UE may dedicate a different transmit power level to its own traffic versus traffic for the cooperative UE group. The UE may have to distinguish between PHRs to determine a correct transmit power level. Other examples may involve a buffer status report (BSR), a DRX command, an SCell activation or deactivation, TCI state activation or deactivation, BFR, and/or a delay status report (DSR). An inability for the MAC subPDU (or the MAC subheader) to indicate whether the MAC subPDU is for the cooperative UE group or for the individual UE may impact a processing of the MAC subPDU at the UE, thereby degrading an overall system performance.

In various aspects of techniques and apparatuses described herein, a UE may communicate, to a network node, or alternatively, the network node may communicate to the UE, a MAC PDU that includes a MAC subheader and a MAC subPDU associated with the MAC subheader. The MAC PDU may be associated with a MAC-CE. The MAC-CE may be a group and/or UE-specific MAC-CE for UE cooperation. The MAC subheader may include one or more fields to indicate whether the MAC subPDU is associated with a cooperative UE group or whether the MAC subPDU is associated with an individual UE that is within the cooperative UE group or outside of the cooperative UE group. The one or more fields may include a flag to indicate whether the MAC subPDU is associated with the cooperative UE group or whether the MAC subPDU is associated with the individual UE. In some aspects, the MAC subheader may indicate a group ID associated with the cooperative UE group. In some aspects, the MAC subheader may indicate the group ID associated with the cooperative group and a UE ID of the individual UE that is within the cooperative UE group. In some aspects, the MAC subheader may indicate a UE ID of the individual UE that is outside of the cooperative UE group.

In some aspects, by incorporating the one or more fields in the MAC subheader to indicate whether the MAC subPDU is associated with a cooperative UE group or whether the MAC subPDU is associated with an individual UE that is within the cooperative UE group or outside of the cooperative UE group, the UE and/or the network node may be able to distinguish, at a MAC layer, whether the MAC subPDU is for the cooperative UE group or the individual UE. Such a distinction may allow the UE and/or the network node to determine whether the MAC subPDU is associated with cooperative services or other activities, such as video streaming. The distinction may allow the UE and/or the network node to perform actions related to various types of procedures, such as a power headroom reporting, a buffer status reporting, a DRX, an SCell activation, an SCell deactivation, a TCI state activation, a TCI state deactivation, a BFR, and/or a delay status reporting. An ability to distinguish at the MAC layer whether the MAC subPDU is intended for the cooperative UE group or the individual UE, through assigning group IDs to cooperative UE groups and using the one or more fields in the MAC subheader, may improve a resource allocation, a communication efficiency, and/or energy savings in cooperative networks, thereby improving an overall system performance.

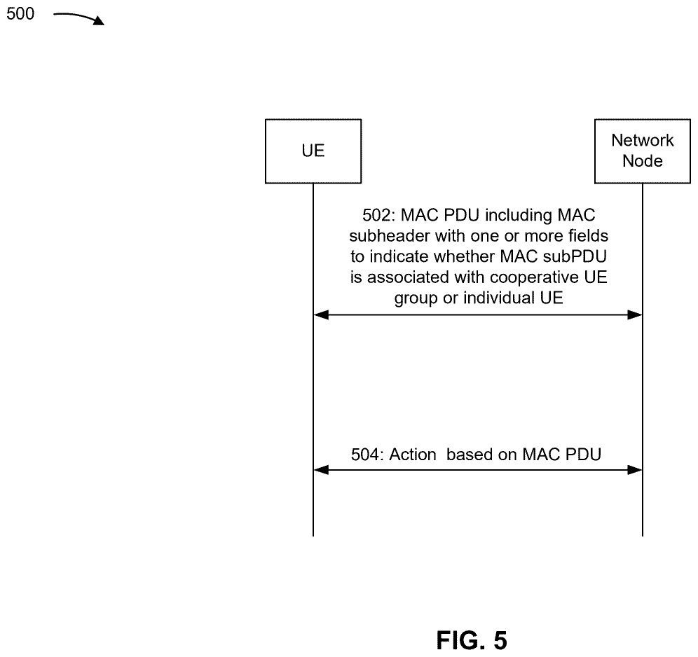

FIG. 5 is a diagram illustrating an example 500 associated with MAC PDUs associated with cooperative UE groups. As shown in FIG. 5, example 500 includes communication between a UE (e.g., UE 120) and a network node (e.g., network node 110). In some aspects, the UE and the network node may be included in a wireless network, such as wireless network 100.

As shown by reference number 502, the UE may communicate, to the network node, or alternatively, the network node may communicate to the UE, a MAC PDU that includes a MAC subheader and a MAC subPDU associated with the MAC subheader. The MAC PDU may be associated with a MAC-CE. The MAC PDU may include a plurality of MAC subheaders, where each MAC subheader may be associated with a respective MAC subPDU. The MAC subheader may include one or more fields to indicate whether the MAC subPDU is associated with a cooperative UE group or whether the MAC subPDU is associated with an individual UE that is within the cooperative UE group or outside of the cooperative UE group. The cooperative UE group may be a group of UEs that are formed, where UEs in the cooperative UE group may provide communication and/or computing services to other UEs in the cooperative UE group. The one or more fields may include a flag to indicate whether the MAC subPDU is associated with the cooperative UE group or whether the MAC subPDU is associated with the individual UE.

In some aspects, the cooperative UE group may be assigned a group ID. Each UE of a plurality of UEs in the cooperative UE group may be associated with the group ID. The UE may be associated with one or more cooperative UE groups. In some aspects, the MAC subheader may indicate the group ID associated with the cooperative UE group. In some aspects, the MAC subheader may indicate the group ID associated with the cooperative UE group and a UE ID of the individual UE that is within the cooperative UE group. In some aspects, the MAC subheader may indicate a UE ID of the individual UE that is outside of the cooperative UE group. In some aspects, the individual UE may be associated with the UE ID. The UE ID may be a global ID, a temporary ID, an ID assigned to the individual UE that is within the cooperative UE group after the cooperative UE group is formed, or an index to a list of configured UE IDs that are not associated with the cooperative UE group.

In some aspects, the cooperative UE group may be assigned the group ID and the MAC PDU may be associated with a MAC-CE, where different lists of groups may be configured for different MAC-CEs. In some aspects, the MAC-CE may be a multiple entry MAC-CE that includes a plurality of sub-MAC-CEs. Each sub-MAC-CE in the plurality of sub-MAC-CEs may be associated with the cooperative UE group or the individual UE. The plurality of sub-MAC-CEs may be associated with a same logical channel identifier (LCID). The MAC-CE may include a maximum number of sub-MAC-CEs, where the maximum number may be a predefined maximum number or may be configured by a cell. The UE may transmit, to the network node, an indication of a UE capability regarding the multiple entry MAC-CE. The indication may indicate one or more cooperative UE groups or one or more individual UEs for which the multiple entry MAC-CE is supported.

In some aspects, each cooperative UE group may be assigned the group ID. Each UE in a same cooperative UE group may have a same group ID. One UE may participate in multiple cooperative UE groups, in which case the UE may be assigned multiple group IDs. In some aspects, a MAC subheader may include an additional field to specific whether a MAC subPDU associated with the MAC subheader is intended for the cooperative UE group or the individual UE, which may enable a data/control message to distinguish whether the data/control message is for the cooperative UE group or for the individual UE within a same MAC PDU. The additional field may be a simple flag or a more detailed ID. For example, the MAC subheader may use a received subheader field to indicate whether a corresponding MAC subPDU is associated with the cooperative UE group or the individual UE. The individual UE may be a UE that is outside of the cooperative UE group. Alternatively, the individual UE may be a UE that is within the cooperative UE group.

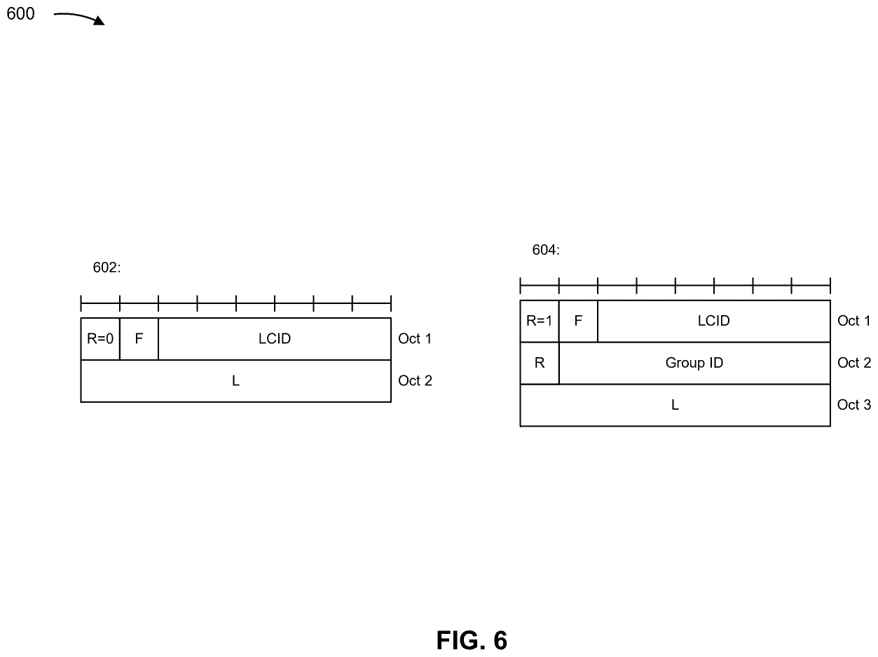

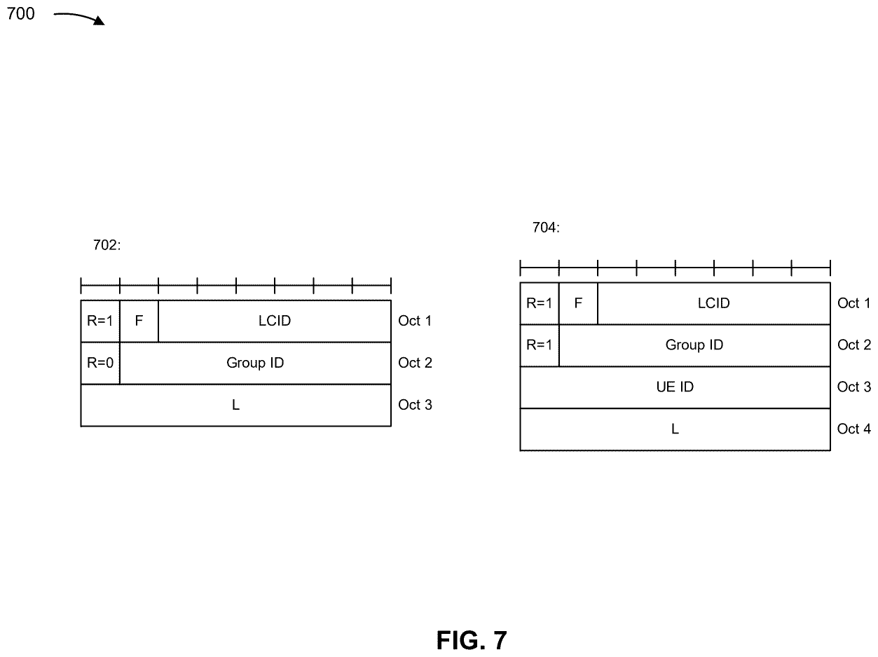

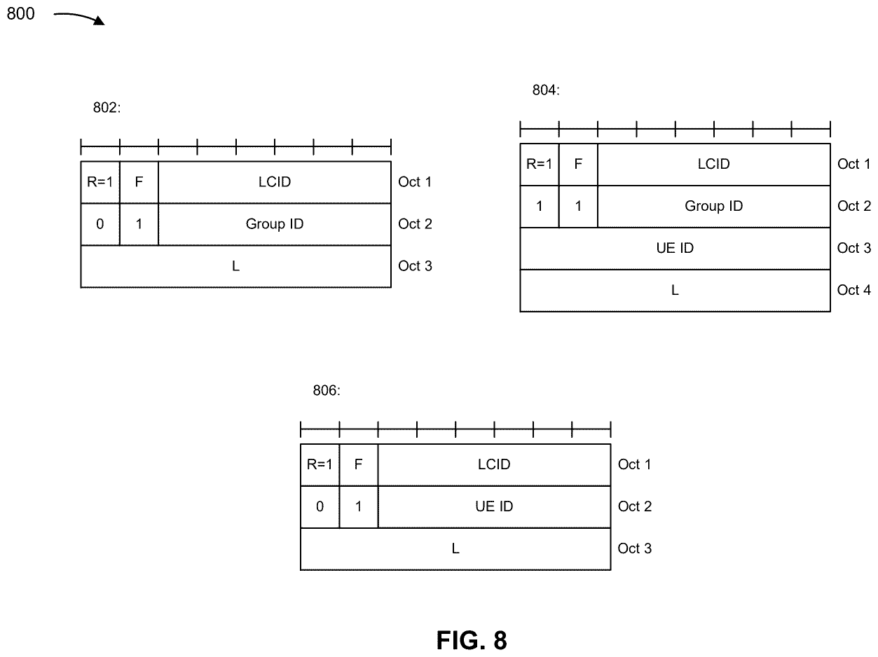

In some aspects, the MAC subheader may include a cooperative UE group ID (also referred to as group ID) when the corresponding MAC subPDU is for the cooperative UE group (e.g., as shown in FIG. 6). In this example, the MAC subPDU may be intended for all UEs within the cooperative UE group. In some aspects, the MAC subheader may include a UE ID when the corresponding MAC subPDU is for a particular UE in the cooperative UE group (e.g., as shown in FIG. 7). In this example, the MAC subPDU may not be intended for all UEs within the cooperative UE group, but rather the MAC subPDU may only be intended for the particular UE in the cooperative UE group. In some aspects, the MAC subheader may include the UE ID when the corresponding MAC subPDU is for another UE that is not necessarily associated with the cooperative UE group (e.g., as shown in FIG. 8). For example, one extra bit or one less bit may be used to indicate the UE ID of the UE that is not in the cooperative UE group, as compared to indicating the UE ID of the UE that is within the cooperative UE group. In this example, the other UE may be an individual UE that is outside of the cooperative UE group.

In some aspects, the UE ID, regardless of whether the UE is within the cooperative UE group or outside of the cooperative UE group, may be a global ID, such as a UE's 5G serving temporary mobile subscriber identity (S-TMSI). The UE ID may be a temporary ID, such as a UE's cell radio network temporary identifier (C-RNTI) or IP address. The UE ID may be an ID assigned to the UE in the cooperative UE group when the cooperative UE group is formed. The UE ID may be an index to a list of RRC-configured UE IDs without being associated with a cooperative UE group. In some aspects, for the cooperative UE group ID, different lists of groups may be configured for different MAC-CEs. For example, a first list of groups (e.g., a first list of N1 groups) may be configured to be used for power headroom reporting, and a second list of groups (e.g., a second list of N2 groups) may be configured to be used for BFR. The cooperative UE group ID indicated in the MAC-CE may be an index to a configured list of groups associated with that MAC-CE.

In some aspects, multiple entry MAC-CEs may be supported in a network. For example, in the same MAC-CE (with the same LCID and other headers), the UE and the network node may include sub-MAC-CEs for cooperative UE groups and individual UEs that are outside of the cooperative UE groups. Alternatively, an LCID may be extended, and separate LCIDs may be used for cooperative/delegated MAC-CEs. A maximum number of sub-MAC-CEs may be allowed to be combined together for a given MAC-CE. The maximum number may be predefined in a specification, or the maximum number may be configured/indicated by a cell. The maximum number may be MAC-CE specific (e.g., different MAC-CEs may be allowed to have different maximum values). A limitation may be placed on which cooperative UE groups and/or individual UEs are able to be combined in a single MAC-CE. For example, for power headroom reporting, the UE may be able to combine PHRs from a first set of cooperative UE groups, but the UE may not be able to combine cooperative UE groups from a first set of cooperative UE groups and a second set of cooperative UE groups. For reporting the second set of cooperative UE groups, the UE may transmit a separate PHR MAC-CE. When a multiple entry or combined MAC-CE is implemented, various signaling optimizations may be employed. For example, a delta value may be indicated for a given parameter, where the delta value may be in relation to a reference value. The reference value may be a first entry in the MAC-CE or a specifically indicated entry in the MAC-CE. In some aspects, the UE may indicate for which cooperative UE groups and individual UEs, and for which MAC-CEs, the UE is able to support the cooperative/delegated MAC-CEs. The UE may indicate a list of cooperative UE groups or a list of other UEs for which the UE is able to support multiple entry MAC-CEs.

As shown by reference number 504, the UE and/or the network node may perform an action based at least in part on the MAC PDU. The UE may transmit signaling to the network node, or alternatively, the network node may transmit signaling to the UE, where the signaling may be associated with the action. For example, the action and/or the signaling may be associated with a power headroom reporting, a buffer status reporting, a DRX, an SCell activation, an SCell deactivation, a TCI state activation, a TCI state deactivation, a BFR, and/or a delay status reporting. The action and/or the signaling may depend on whether the MAC subPDU is associated with the cooperative UE group. The action and/or the signaling may depend on whether the MAC subPDU is associated with the individual UE.

As indicated above, FIG. 5 is provided as an example. Other examples may differ from what is described with regard to FIG. 5.

FIG. 6 is a diagram illustrating an example 600 associated with MAC PDUs associated with cooperative UE groups.

As shown by reference number 602, a MAC subheader of a MAC subPDU for one UE may indicate a reserved (R) field (e.g., R=0), a format (F) field, a logical channel ID (LCID), and a length (L) field. The R field, the F field, and the LCID field may be associated with octet 1, and the L field may be associated with octet 2. As shown by reference number 604, a MAC subheader of a MAC subPDU for a cooperative UE group may include a group ID. An R field (e.g., R=1), an F field, and an LCID may be associated with octet 1. An R field and the group ID may be associated with octet 2. An L field may be associated with octet 3.

As indicated above, FIG. 6 is provided as an example. Other examples may differ from what is described with regard to FIG. 6.

FIG. 7 is a diagram illustrating an example 700 associated with MAC PDUs associated with cooperative UE groups.

As shown by reference number 702, a MAC subheader of a MAC subPDU for a cooperative UE group may include a group ID. An R field (e.g., R=1), an F field, and an LCID may be associated with octet 1. An R field (e.g., R=0) and the group ID may be associated with octet 2. An L field may be associated with octet 3. As shown by reference number 704, a MAC subheader of a MAC subPDU may include a UE ID for a particular UE in a cooperative UE group. An R field (e.g., R=1), an F field, and an LCID may be associated with octet 1. An R field (e.g., R=1) and a group ID may be associated with octet 2. The UE ID may be associated with octet 3. An L field may be associated with octet 4.

As indicated above, FIG. 7 is provided as an example. Other examples may differ from what is described with regard to FIG. 7.

FIG. 8 is a diagram illustrating an example 800 associated with MAC PDUs associated with cooperative UE groups.

As shown by reference number 802, a MAC subheader of a MAC subPDU for a cooperative UE group may include a group ID. An R field (e.g., R=1), an F field, and an LCID may be associated with octet 1. An R field (e.g., R=0), an F field (e.g., F=0), and the group ID may be associated with octet 2. An L field may be associated with octet 3. As shown by reference number 804, a MAC subheader of a MAC subPDU may include a UE ID for a particular UE in a cooperative UE group. An R field (e.g., R=1), an F field, and an LCID may be associated with octet 1. An R field (e.g., R=1), an F field (e.g., F=0), and a group ID may be associated with octet 2. The UE ID may be associated with octet 3. An L field may be associated with octet 4. As shown by reference number 806, a MAC subheader of a MAC subPDU may include a UE ID of a UE that is not associated with a cooperative UE group. An R field (e.g., R=1), an F field, and an LCID may be associated with octet 1. An R field (e.g., R=0), an F field (e.g., F=1), and the UE ID may be associated with octet 2. An L field may be associated with octet 3.

As indicated above, FIG. 8 is provided as an example. Other examples may differ from what is described with regard to FIG. 8.

FIG. 9 is a diagram illustrating an example process 900 performed, for example, at a UE or an apparatus of a UE. Example process 900 is an example where the apparatus or the UE (e.g., UE 120) performs operations associated with MAC PDUs associated with cooperative UE groups.

As shown in FIG. 9, in some aspects, process 900 may include communicating a MAC PDU that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group (block 910). For example, the UE (e.g., using reception component 1102, transmission component 1104, or communication manager 1106, depicted in FIG. 11) may communicate a MAC PDU that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group, as described above.

As further shown in FIG. 9, in some aspects, process 900 may include performing an action based at least in part on the MAC PDU (block 920). For example, the UE (e.g., using communication manager 1106, depicted in FIG. 11) may perform an action based at least in part on the MAC PDU, as described above.

Process 900 may include additional aspects, such as any single aspect or any combination of aspects described below or in connection with one or more other processes described elsewhere herein.

In a first aspect, the one or more fields includes a flag to indicate whether the MAC subPDU is associated with the cooperative UE group or whether the MAC subPDU is associated with the individual UE.

In a second aspect, alone or in combination with the first aspect, the cooperative UE group is assigned a group ID, wherein each UE of a plurality of UEs in the cooperative UE group is associated with the group ID, and the UE is associated with one or more cooperative UE groups.

In a third aspect, alone or in combination with one or more of the first and second aspects, the MAC subheader indicates a group ID associated with the cooperative UE group.

In a fourth aspect, alone or in combination with one or more of the first through third aspects, the MAC subheader indicates a group ID associated with the cooperative UE group and a UE ID of the individual UE that is within the cooperative UE group.

In a fifth aspect, alone or in combination with one or more of the first through fourth aspects, the MAC subheader indicates a UE ID of the individual UE that is outside of the cooperative UE group.

In a sixth aspect, alone or in combination with one or more of the first through fifth aspects, the individual UE is associated with a UE ID, and the UE ID is one of a global ID, a temporary ID, an ID assigned to the individual UE that is within the cooperative UE group after the cooperative UE group is formed, or an index to a list of configured UE IDs that are not associated with the cooperative UE group.

In a seventh aspect, alone or in combination with one or more of the first through sixth aspects, the cooperative UE group is assigned a group ID and the MAC PDU is associated with a MAC-CE, and different lists of groups are configured for different MAC-CEs.

In an eighth aspect, alone or in combination with one or more of the first through seventh aspects, the MAC PDU is associated with MAC-CE, wherein the MAC-CE is a multiple entry MAC-CE that includes a plurality of sub-MAC-CEs, and each sub-MAC-CE in the plurality of sub-MAC-CEs is associated with the cooperative UE group or the individual UE.

In a ninth aspect, alone or in combination with one or more of the first through eighth aspects, the plurality of sub-MAC-CEs are associated with a same LCID.

In a tenth aspect, alone or in combination with one or more of the first through ninth aspects, the MAC-CE may include a maximum number of sub-MAC-CEs, and the maximum number is a predefined maximum number or is configured by a cell.

In an eleventh aspect, alone or in combination with one or more of the first through tenth aspects, process 900 includes transmitting an indication of a UE capability regarding the multiple entry MAC-CE, wherein the indication indicates one or more cooperative UE groups or one or more individual UEs for which the multiple entry MAC-CE is supported.

In a twelfth aspect, alone or in combination with one or more of the first through eleventh aspects, the action is associated with one or more of a power headroom reporting, a buffer status reporting, a DRX, an SCell activation, an SCell deactivation, a TCI state activation, a TCI state deactivation, a BFR, or a delay status reporting.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node. Example process 1000 is an example where the apparatus or the network node (e.g., network node 110) performs operations associated with MAC PDUs associated with cooperative UE groups.

As shown in FIG. 10, in some aspects, process 1000 may include communicating a MAC PDU that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group (block 1010). For example, the network node (e.g., using reception component 1202, transmission component 1204, or communication manager 1206, depicted in FIG. 12) may communicate a MAC PDU that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group, as described above.

As further shown in FIG. 10, in some aspects, process 1000 may include performing an action based at least in part on the MAC PDU (block 1020). For example, the network node (e.g., using communication manager 1206, depicted in FIG. 12) may perform an action based at least in part on the MAC PDU, as described above.

Process 1000 may include additional aspects, such as any single aspect or any combination of aspects described below or in connection with one or more other processes described elsewhere herein.

In a first aspect, the one or more fields includes a flag to indicate whether the MAC subPDU is associated with the cooperative UE group or whether the MAC subPDU is associated with the individual UE.

In a second aspect, alone or in combination with the first aspect, the cooperative UE group is assigned a group ID, wherein each UE of a plurality of UEs in the cooperative UE group is associated with the group ID, and the UE is associated with one or more cooperative UE groups.

In a third aspect, alone or in combination with one or more of the first and second aspects, the MAC subheader indicates a group ID associated with the cooperative UE group.

In a fourth aspect, alone or in combination with one or more of the first through third aspects, the MAC subheader indicates a group ID associated with the cooperative UE group and a UE ID of the individual UE that is within the cooperative UE group.

In a fifth aspect, alone or in combination with one or more of the first through fourth aspects, the MAC subheader indicates a UE ID of the individual UE that is outside of the cooperative UE group.

In a sixth aspect, alone or in combination with one or more of the first through fifth aspects, the individual UE is associated with a UE ID, and the UE ID is one of a global ID, a temporary ID, an ID assigned to the individual UE that is within the cooperative UE group after the cooperative UE group is formed, or an index to a list of configured UE IDs that are not associated with the cooperative UE group.

In a seventh aspect, alone or in combination with one or more of the first through sixth aspects, the cooperative UE group is assigned a group ID and the MAC PDU is associated with a MAC-CE, and different lists of groups are configured for different MAC-CEs.

In an eighth aspect, alone or in combination with one or more of the first through seventh aspects, the MAC PDU is associated with a MAC-CE, wherein the MAC-CE is a multiple entry MAC-CE that includes a plurality of sub-MAC-CEs, and each sub-MAC-CE in the plurality of sub-MAC-CEs is associated with the cooperative UE group or the individual UE.

In a ninth aspect, alone or in combination with one or more of the first through eighth aspects, the plurality of sub-MAC-CEs are associated with a same LCID.

In a tenth aspect, alone or in combination with one or more of the first through ninth aspects, the MAC-CE may include a maximum number of sub-MAC-CEs, and the maximum number is a predefined maximum number or is configured by a cell.

In an eleventh aspect, alone or in combination with one or more of the first through tenth aspects, process 1000 includes receiving an indication of a UE capability regarding the multiple entry MAC-CE, wherein the indication indicates one or more cooperative UE groups or one or more individual UEs for which the multiple entry MAC-CE is supported.

In a twelfth aspect, alone or in combination with one or more of the first through eleventh aspects, the action is associated with one or more of a power headroom reporting, a buffer status reporting, a DRX, an SCell activation, an SCell deactivation, a TCI state activation, a TCI state deactivation, a BFR, or a delay status reporting.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 5-8. Additionally, or alternatively, the apparatus 1100 may be configured to perform one or more processes described herein, such as process 900 of FIG. 9. In some aspects, the apparatus 1100 or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The reception component 1102 or the transmission component 1104 may communicate a MAC PDU that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group. The communication manager 1106 may perform an action based at least in part on the MAC PDU. The transmission component 1104 may transmit an indication of a UE capability regarding the multiple entry MAC-CE, wherein the indication indicates one or more cooperative UE groups or one or more individual UEs for which the multiple entry MAC-CE is supported.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network node, or a network node may include the apparatus 1200. In some aspects, the apparatus 1200 includes a reception component 1202, a transmission component 1204, or a communication manager 1206, which may be in communication with one another (for example, via one or more buses or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 5-8. Additionally, or alternatively, the apparatus 1200 may be configured to perform one or more processes described herein, such as process 1000 of FIG. 10. In some aspects, the apparatus 1200 or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 or the transmission component 1204 may include or may be included in a network interface. The network interface may be configured to obtain or output signals for the apparatus 1200 via one or more communications links, such as a backhaul link, a midhaul link, or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 or the transmission component 1204. For example, the communication manager 1206 may receive information associated with configuring reception of communications by the reception component 1202 or transmission of communications by the transmission component 1204. Additionally, or alternatively, the communication manager 1206 may generate or provide control information to the reception component 1202 or the transmission component 1204 to control reception or transmission of communications.

The reception component 1202 or the transmission component 1204 may communicate a MAC PDU that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group. The communication manager 1206 may perform an action based at least in part on the MAC PDU. The reception component 1202 may receive an indication of a UE capability regarding the multiple entry MAC-CE, wherein the indication indicates one or more cooperative UE groups or one or more individual UEs for which the multiple entry MAC-CE is supported.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: communicating a medium access control (MAC) protocol data unit (PDU) that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group; and performing an action based at least in part on the MAC PDU.

Aspect 2: The method of Aspect 1, wherein the one or more fields includes a flag to indicate whether the MAC subPDU is associated with the cooperative UE group or whether the MAC subPDU is associated with the individual UE.

Aspect 3: The method of any of Aspects 1-2, wherein the cooperative UE group is assigned a group identifier (ID), wherein each UE of a plurality of UEs in the cooperative UE group is associated with the group ID, and wherein the UE is associated with one or more cooperative UE groups.

Aspect 4: The method of any of Aspects 1-3, wherein the MAC subheader indicates a group identifier (ID) associated with the cooperative UE group.

Aspect 5: The method of any of Aspects 1-4, wherein the MAC subheader indicates a group identifier (ID) associated with the cooperative UE group and a UE ID of the individual UE that is within the cooperative UE group.

Aspect 6: The method of any of Aspects 1-5, wherein the MAC subheader indicates a UE identifier (ID) of the individual UE that is outside of the cooperative UE group.

Aspect 7: The method of any of Aspects 1-6, wherein the individual UE is associated with a UE identifier (ID), and wherein the UE ID is one of: a global ID, a temporary ID, an ID assigned to the individual UE that is within the cooperative UE group after the cooperative UE group is formed, or an index to a list of configured UE IDs that are not associated with the cooperative UE group.

Aspect 8: The method of any of Aspects 1-7, wherein the cooperative UE group is assigned a group identifier (ID) and the MAC PDU is associated with a MAC control element (MAC-CE), and wherein different lists of groups are configured for different MAC-CEs.

Aspect 9: The method of any of Aspects 1-8, wherein the MAC PDU is associated with a MAC control element (MAC-CE), wherein the MAC-CE is a multiple entry MAC-CE that includes a plurality of sub-MAC-CEs, and wherein each sub-MAC-CE in the plurality of sub-MAC-CEs is associated with the cooperative UE group or the individual UE.

Aspect 10: The method of Aspect 9, wherein the plurality of sub-MAC-CEs are associated with a same logical channel identifier.

Aspect 11: The method of Aspect 9, wherein the MAC-CE may include a maximum number of sub-MAC-CEs, and wherein the maximum number is a predefined maximum number or is configured by a cell.

Aspect 12: The method of Aspect 9, further comprising: transmitting an indication of a UE capability regarding the multiple entry MAC-CE, wherein the indication indicates one or more cooperative UE groups or one or more individual UEs for which the multiple entry MAC-CE is supported.

Aspect 13: The method of any of Aspects 1-12, wherein the action is associated with one or more of: a power headroom reporting, a buffer status reporting, a discontinuous reception, a secondary cell (SCell) activation, an SCell deactivation, a transmission configuration indicator (TCI) state activation, a TCI state deactivation, a beam failure recovery, or a delay status reporting.

Aspect 14: A method of wireless communication performed by a network node, comprising: communicating a medium access control (MAC) protocol data unit (PDU) that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group; and performing an action based at least in part on the MAC PDU.

Aspect 15: The method of Aspect 14, wherein the one or more fields includes a flag to indicate whether the MAC subPDU is associated with the cooperative UE group or whether the MAC subPDU is associated with the individual UE.

Aspect 16: The method of any of Aspects 14-15, wherein the cooperative UE group is assigned a group identifier (ID), wherein each UE of a plurality of UEs in the cooperative UE group is associated with the group ID, and wherein the UE is associated with one or more cooperative UE groups.

Aspect 17: The method of any of Aspects 14-16, wherein the MAC subheader indicates a group identifier (ID) associated with the cooperative UE group.

Aspect 18: The method of any of Aspects 14-17, wherein the MAC subheader indicates a group identifier (ID) associated with the cooperative UE group and a UE ID of the individual UE that is within the cooperative UE group.

Aspect 19: The method of any of Aspects 14-18, wherein the MAC subheader indicates a UE identifier (ID) of the individual UE that is outside of the cooperative UE group.

Aspect 20: The method of any of Aspects 14-19, wherein the individual UE is associated with a UE identifier (ID), and wherein the UE ID is one of: a global ID, a temporary ID, an ID assigned to the individual UE that is within the cooperative UE group after the cooperative UE group is formed, or an index to a list of configured UE IDs that are not associated with the cooperative UE group.

Aspect 21: The method of any of Aspects 14-20, wherein the cooperative UE group is assigned a group identifier (ID) and the MAC PDU is associated with a MAC control element (MAC-CE), and wherein different lists of groups are configured for different MAC-CEs.

Aspect 22: The method of any of Aspects 14-21, wherein the MAC PDU is associated with a MAC control element (MAC-CE), wherein the MAC-CE is a multiple entry MAC-CE that includes a plurality of sub-MAC-CEs, and wherein each sub-MAC-CE in the plurality of sub-MAC-CEs is associated with the cooperative UE group or the individual UE.

Aspect 23: The method of Aspect 22, wherein the plurality of sub-MAC-CEs are associated with a same logical channel identifier.

Aspect 24: The method of Aspect 22, wherein the MAC-CE may include a maximum number of sub-MAC-CEs, and wherein the maximum number is a predefined maximum number or is configured by a cell.

Aspect 25: The method of Aspect 22, further comprising: receiving an indication of a UE capability regarding the multiple entry MAC-CE, wherein the indication indicates one or more cooperative UE groups or one or more individual UEs for which the multiple entry MAC-CE is supported.

Aspect 26: The method of any of Aspects 14-25, wherein the action is associated with one or more of: a power headroom reporting, a buffer status reporting, a discontinuous reception, a secondary cell (SCell) activation, an SCell deactivation, a transmission configuration indicator (TCI) state activation, a TCI state deactivation, a beam failure recovery, or a delay status reporting.

Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-26.

Aspect 28: An apparatus for wireless communication at a device, the apparatus comprising one or more memories and one or more processors coupled to the one or more memories, the one or more processors configured to cause the device to perform the method of one or more of Aspects 1-26.

Aspect 29: An apparatus for wireless communication, the apparatus comprising at least one means for performing the method of one or more of Aspects 1-26.

Aspect 30: A non-transitory computer-readable medium storing code for wireless communication, the code comprising instructions executable by one or more processors to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

Aspect 32: A device for wireless communication, the device comprising a processing system that includes one or more processors and one or more memories coupled with the one or more processors, the processing system configured to cause the device to perform the method of one or more of Aspects 1-26.

Aspect 33: An apparatus for wireless communication at a device, the apparatus comprising one or more memories and one or more processors coupled to the one or more memories, the one or more processors individually or collectively configured to cause the device to perform the method of one or more of Aspects 1-26.

Aspect 34: A device comprising a processing system that includes one or more processors and one or more code-storing memories coupled with the one or more processors, the processing system configured to cause the device to perform the method of one or more of Aspects 1-26.

Aspect 35: A device comprising a processing system that includes processor circuitry and code-storing memory circuitry, the processing system configured to cause the device to perform the method of one or more of Aspects 1-26.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
communicate a medium access control (MAC) protocol data unit (PDU) that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group; and
perform an action based at least in part on the MAC PDU.

2. The apparatus of claim 1, wherein the one or more fields includes a flag to indicate whether the MAC subPDU is associated with the cooperative UE group or whether the MAC subPDU is associated with the individual UE.

3. The apparatus of claim 1, wherein the cooperative UE group is assigned a group identifier (ID), wherein each UE of a plurality of UEs in the cooperative UE group is associated with the group ID, and wherein the UE is associated with one or more cooperative UE groups.

4. The apparatus of claim 1, wherein the MAC subheader indicates a group identifier (ID) associated with the cooperative UE group.

5. The apparatus of claim 1, wherein the MAC subheader indicates a group identifier (ID) associated with the cooperative UE group and a UE ID of the individual UE that is within the cooperative UE group.

6. The apparatus of claim 1, wherein the MAC subheader indicates a UE identifier (ID) of the individual UE that is outside of the cooperative UE group.

7. The apparatus of claim 1, wherein the individual UE is associated with a UE identifier (ID), and wherein the UE ID is one of: a global ID, a temporary ID, an ID assigned to the individual UE that is within the cooperative UE group after the cooperative UE group is formed, or an index to a list of configured UE IDs that are not associated with the cooperative UE group.

8. The apparatus of claim 1, wherein the cooperative UE group is assigned a group identifier (ID) and the MAC PDU is associated with a MAC control element (MAC-CE), and wherein different lists of groups are configured for different MAC-CEs.

9. The apparatus of claim 1, wherein the MAC PDU is associated with a MAC control element (MAC-CE), wherein the MAC-CE is a multiple entry MAC-CE that includes a plurality of sub-MAC-CEs, and wherein each sub-MAC-CE in the plurality of sub-MAC-CEs is associated with the cooperative UE group or the individual UE.

10. The apparatus of claim 9, wherein the plurality of sub-MAC-CEs are associated with a same logical channel identifier.

11. The apparatus of claim 9, wherein the MAC-CE may include a maximum number of sub-MAC-CEs, and wherein the maximum number is a predefined maximum number or is configured by a cell.

12. The apparatus of claim 9, wherein the one or more processors are further configured to cause the UE to:
transmit an indication of a UE capability regarding the multiple entry MAC-CE, wherein the indication indicates one or more cooperative UE groups or one or more individual UEs for which the multiple entry MAC-CE is supported.

13. The apparatus of claim 1, wherein the action is associated with one or more of: a power headroom reporting, a buffer status reporting, a discontinuous reception, a secondary cell (SCell) activation, an SCell deactivation, a transmission configuration indicator (TCI) state activation, a TCI state deactivation, a beam failure recovery, or a delay status reporting.

14. An apparatus for wireless communication at a network node, comprising:
one or more memories; and
one or more processors, coupled to the one or more memories, configured to cause the network node to:
communicate a medium access control (MAC) protocol data unit (PDU) that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group; and
perform an action based at least in part on the MAC PDU.

15. The apparatus of claim 14, wherein the cooperative UE group is assigned a group identifier (ID), wherein each UE of a plurality of UEs in the cooperative UE group is associated with the group ID, and wherein the UE is associated with one or more cooperative UE groups.

16. The apparatus of claim 14, wherein:
the MAC subheader indicates a group identifier (ID) associated with the cooperative UE group;
the MAC subheader indicates the group ID associated with the cooperative UE group and a UE ID of the individual UE that is within the cooperative UE group; or
the MAC subheader indicates a UE ID of the individual UE that is outside of the cooperative UE group.

17. The apparatus of claim 14, wherein the individual UE is associated with a UE identifier (ID), and wherein the UE ID is one of: a global ID, a temporary ID, an ID assigned to the individual UE that is within the cooperative UE group after the cooperative UE group is formed, or an index to a list of configured UE IDs that are not associated with the cooperative UE group.

18. The apparatus of claim 14, wherein the cooperative UE group is assigned a group identifier (ID) and the MAC PDU is associated with a MAC control element (MAC-CE), and wherein different lists of groups are configured for different MAC-CEs.

19. The apparatus of claim 14, wherein the MAC PDU is associated with a MAC control element (MAC-CE), wherein the MAC-CE is a multiple entry MAC-CE that includes a plurality of sub-MAC-CEs, and wherein each sub-MAC-CE in the plurality of sub-MAC-CEs is associated with the cooperative UE group or the individual UE.

20. A method of wireless communication performed by a user equipment (UE), comprising:
communicating a medium access control (MAC) protocol data unit (PDU) that includes a MAC subheader and a MAC subPDU associated with the MAC subheader, wherein the MAC subheader includes one or more fields to indicate whether the MAC subPDU is associated with a cooperative UE group or whether the MAC subPDU is associated with an individual UE that is within the cooperative UE group or outside of the cooperative UE group; and
performing an action based at least in part on the MAC PDU.
